(19) United States
(12) Patent Application Publication
(10) Pub. No.: US 2023/0259201 A1
(43) Pub. Date: Aug. 17, 2023

(54) METHOD FOR ZOOMING VISUAL CONTENT, HOST, AND COMPUTER READABLE MEDIUM

(71) Applicant: HTC Corporation, Taoyuan City (TW)

(72) Inventor: Huan-Cheng Hsu, Taoyuan City (TW)

(73) Assignee: HTC Corporation, Taoyuan City (TW)

(21) Appl. No.: 17/672,708

(22) Filed: Feb. 16, 2022

(51) Int. Cl. G06F 3/01; G06T 3/40

(52) U.S. Cl. CPC G06F 3/013; G06T 3/40

(57) ABSTRACT

The embodiments of the disclosure provide a method for zooming a visual content, a host, and a computer readable medium. The method includes: detecting a first wink movement of a first eye of a user and detecting a second wink movement of a second eye of the user; in response to determining that the first wink movement matches a first predetermined wink movement but the second wink movement fails to match a second predetermined wink movement, zooming in the visual content; and in response to determining that the second wink movement matches a second predetermined wink movement but the first wink movement fails to match the first predetermined wink movement, zooming out the visual content.

### 1. FIELD OF THE INVENTION

The present disclosure generally relates to a visual content adjusting mechanism, in particular, to a method for zooming a visual content, a host, and a computer readable medium.

### 2. DESCRIPTION OF RELATED ART

Nowadays, watching visual contents (e.g., virtual reality (VR) contents) provided by devices such as head-mounted displays (HMDs) has been a common activity of people. While interacting with the visual contents, the user may need to zoom in/out the visual content from time to time for better interaction.

Conventionally, the user may zoom the visual content via ways such as two-finger dragging and/or particular handheld controller movements, which may interfere the immersive experience of the user.

Therefore, it is crucial to provide a design for the users to zoom the visual content in an easier and more intuitive way.

### SUMMARY OF THE INVENTION

Accordingly, the disclosure is directed to a method for zooming a visual content, a host, and a computer readable medium, which may be used to solve the above technical problems.

The embodiments of the disclosure provide a method for zooming a visual content, adapted to a host. The method includes: detecting a first wink movement of a first eye of a user and detecting a second wink movement of a second eye of the user; in response to determining that the first wink movement matches a first predetermined wink movement but the second wink movement fails to match a second predetermined wink movement, zooming in the visual content; and in response to determining that the second wink movement matches a second predetermined wink movement but the first wink movement fails to match the first predetermined wink movement, zooming out the visual content.

The embodiments of the disclosure provide a host including a storage circuit and a processor. The storage circuit stores a program code. The processor is coupled to the non-transitory storage circuit and accessing the program code to perform: detecting a first wink movement of a first eye of a user and detecting a second wink movement of a second eye of the user; in response to determining that the first wink movement matches a first predetermined wink movement but the second wink movement fails to match a second predetermined wink movement, zooming in the visual content; and in response to determining that the second wink movement matches a second predetermined wink movement but the first wink movement fails to match the first predetermined wink movement, zooming out the visual content.

The embodiments of the disclosure provide non-transitory computer readable medium, the computer readable medium recording an executable computer program, the executable computer program being loaded by a host to perform steps of: detecting a first wink movement of a first eye of a user and detecting a second wink movement of a second eye of the user; in response to determining that the first wink movement matches a first predetermined wink movement but the second wink movement fails to match a second predetermined wink movement, zooming in the visual content; and in response to determining that the second wink movement matches a second predetermined wink movement but the first wink movement fails to match the first predetermined wink movement, zooming out the visual content.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the disclosure.

FIG. 1 shows a schematic diagram of a host according to an embodiment of the disclosure.

FIG. 2 shows a flow chart of the method for zooming the visual content according to an embodiment of the disclosure.

FIG. 3A shows a schematic diagram of zooming in the visual content according to an embodiment of the disclosure.

FIG. 3B shows a schematic diagram of zooming in the visual content according to an embodiment of the disclosure.

FIG. 4A shows a schematic diagram of zooming out the visual content according to an embodiment of the disclosure.

FIG. 4B shows a schematic diagram of zooming out the visual content according to an embodiment of the disclosure.

FIG. 5 shows a schematic diagram of zooming the visual content according to the first embodiment of the disclosure.

FIG. 6 shows a schematic diagram of zooming the visual content according to the second embodiment of the disclosure.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

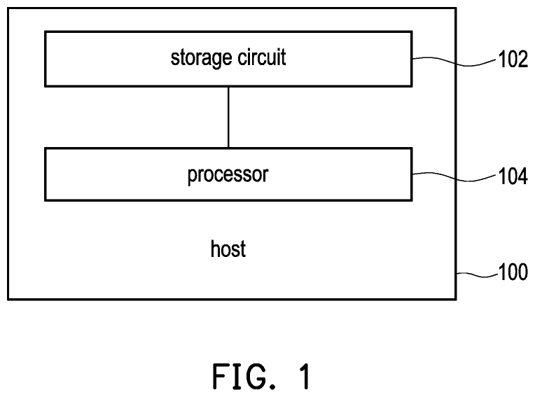

See FIG. 1, which shows a schematic diagram of a host according to an embodiment of the disclosure. In various embodiments, the host 100 can be any electronic device such as a smart device and/or a computer device. In some embodiments, the host 100 can be an HMD of a reality system (e.g., a VR system, an augmented reality (AR) system, a mixed reality (MR) system, or the like). In some embodiments, the host 100 can be a (standalone) HMD providing a visual content (e.g., a VR content) for the user/wearer to see, but the disclosure is not limited thereto.

In some embodiments, the host 100 can be configured with an eye-tracking circuit that can be used to track the eye movements (e.g., eye-closing movements and/or wink movements, etc.) of the two eyes of the user. In one embodiment, the host 100 can be configured with cameras used for capturing images of the eyes of the user, and the host 100 can determine the eye movements of the eyes of the user via analysing the capture images.

In FIG. 1, the host 100 includes a storage circuit 102 and a processor 104. The storage circuit 102 is one or a combination of a stationary or mobile random access memory (RAM), read-only memory (ROM), flash memory, hard disk, or any other similar device, and which records a program code and/or a plurality of modules that can be executed by the processor 104.

The processor 104 is coupled with the storage circuit 102, and the processor 104 may be, for example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like.

In the embodiments of the disclosure, the processor 104 accesses the modules and/or the program code stored in the storage circuit 102 to implement the method for zooming the visual content provided in the disclosure, which would be further discussed in the following.

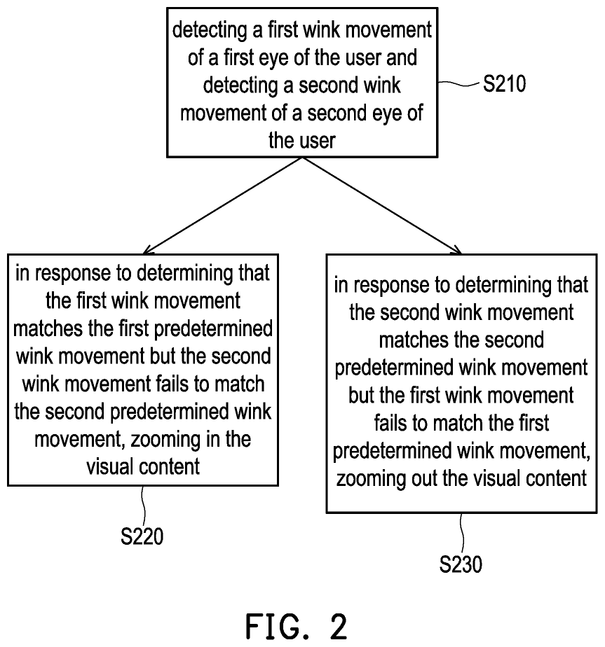

See FIG. 2, which shows a flow chart of the method for zooming the visual content according to an embodiment of the disclosure. The method of this embodiment may be executed by the host 100 in FIG. 1, and the details of each step in FIG. 2 will be described below with the components shown in FIG. 1.

In step S210, the processor 104 detects a first wink movement of a first eye of the user and detecting a second wink movement of a second eye of the user. In the embodiments of the disclosure, the first eye can be one of the eyes of the user, and the second eye can be another of the eyes of the user. As mentioned in the above, the host 100 can track the eye movement of each eye of the user. In one embodiment, in response to determining that an eye of the user has winked, the processor 104 can accordingly determine that this eye has performed a wink movement. In one embodiment, in response to determining that an eye is closed and opened (within a particular duration), the processor 104 may determine that the eye has performed the wink movement, but the disclosure is not limited thereto.

In the embodiments of the disclosure, the processor 104 determines whether that the first wink movement matches a first predetermined wink movement and whether the second wink movement matches a second predetermined wink movement.

In one embodiment, in response to determine that the first wink movement matches the first predetermined wink movement but the second wink movement fails to match the second predetermined wink movement, the processor 104 performs S220 to zoom in the visual content.

In another embodiment, in response to determine that the second wink movement matches the second predetermined wink movement but the first wink movement fails to match the first predetermined wink movement, the processor 104 performs S230 to zoom out the visual content.

In a first embodiment, the processor 104 determines whether the first eye has winked for a first predetermined times within a first predetermined duration. In response to determining that the first eye has winked for the first predetermined times within the first predetermined duration, the processor 104 determines that the first wink movement matches the first predetermined wink movement.

In the first embodiment, the first predetermined times is twice, and the first predetermined duration is one second, but the disclosure is not limited thereto. In this case, if the processor 104 determines that the first eye of the user has winked twice within one second, the processor 104 can determine that the first wink movement of the first eye matches the first predetermined wink movement, but the disclosure is not limited thereto. In detail, since a regular blink/wink rate of a human is about 0.26 time/sec, if the first eye is determined to wink twice within one second (which is significantly higher than the regular blink/wink rate), it represents that the user would like to activate specific operation (e.g., zooming in the visual content) by using the first eye.

In the first embodiment, the second predetermined wink movement can be identical to the first predetermined wink movement. In this case, the processor 104 determines whether the second eye has winked for the first predetermined times within the first predetermined duration. In response to determining that the second eye has winked for the first predetermined times within the first predetermined duration, the processor 104 determines that the second wink movement matches the second predetermined wink movement. That is, if the processor 104 determines that the second eye of the user has winked twice within one second, the processor 104 can determine that the second wink movement of the second eye matches the second predetermined wink movement, but the disclosure is not limited thereto. Similar to the principle mentioned in the above, if the second eye is determined to wink twice within one second, it represents that the user would like to activate specific operation (e.g., zooming out the visual content) by using the second eye.

In some embodiments, the second predetermined wink movement can be designed to be different from the first predetermined wink movement. For example, the processor 104 can determine that the second wink movement matches the second predetermined wink movement when determining that the second eye has winked thrice within two seconds, but the disclosure is not limited thereto.

In a second embodiment, the processor 104 determines whether the first eye has been closed for a first predetermined time length. In response to determining that the first eye has been closed for the first predetermined time length, the processor 104 determines that the first wink movement matches the first predetermined wink movement. In the second embodiment, the first predetermined time length is two seconds. In this case if the processor 104 determines that the first eye of the user has been closed for two seconds, the processor 104 can determine that the first wink movement of the first eye matches the first predetermined wink movement, but the disclosure is not limited thereto. In detail, since a regular blink/wink rate of a human is about 0.26 time/sec, if the first eye is determined to be closed for two seconds (which is significantly lower than the regular blink/wink rate), it represents that the user would like to activate specific operation (e.g., zooming in the visual content) by using the first eye.

In the second embodiment, the second predetermined wink movement can be identical to the first predetermined wink movement. In this case, the processor 104 determines whether the second eye has been closed for the first predetermined time length. In response to determining that the second eye has been closed for the first predetermined time length, the processor 104 determines that the second wink movement matches the second predetermined wink movement. That is, if the processor 104 determines that the second eye of the user has been closed for two seconds, the processor 104 can determine that the second wink movement of the second eye matches the second predetermined wink movement, but the disclosure is not limited thereto. Similar to the principle mentioned in the above, if the second eye is determined to be closed for two seconds, it represents that the user would like to activate specific operation (e.g., zooming out the visual content) by using the second eye.

In some embodiments, the second predetermined wink movement can be designed to be different from the first predetermined wink movement. For example, the processor 104 can determine that the second wink movement matches the second predetermined wink movement when determining that the second eye has been closed for three seconds, but the disclosure is not limited thereto.

In a third embodiment, the processor 104 determines whether the first wink movement and the second wink movement collectively form a specific blink movement. In response to determining that the first wink movement and the second wink movement collectively form the specific blink movement, the processor 104 zooms the visual content to be with a predetermined magnification of the visual content. That is, no matter the visual content has been zoomed in/out to be with which magnification, the processor 104 can zoom the visual content back to the predetermined magnification when determining that the first wink movement and the second wink movement collectively form the specific blink movement.

In the third embodiment, in response to determining that each of the first eye and the second eye has blinked for a second predetermined times within a second predetermined duration, the processor 104 can determine that the first wink movement and the second wink movement collectively form the specific blink movement. In one embodiment, the second predetermined times is twice, and the second predetermined duration is one second. In this case, if the processor 104 determines that each of the first eye and the second eye has blinked twice within one second, the processor 104 can determine that the first wink movement and the second wink movement collectively form the specific blink movement. Similar to the principle mentioned in the above, if the first eye and the second eye are determined to blink twice within one second, it represents that the user would like to activate specific operation (e.g., zooming the visual content to be with the predetermined magnification) by using the first eye and the second eye.

In the third embodiment, in response to determining that the first eye and the second eye have been closed for a second predetermined time length, the processor 104 determines that the first wink movement and the second wink movement collectively form the specific blink movement. In one embodiment, the second predetermined time length is two seconds.

In the third embodiment, in response to determining that the first wink movement matches the first predetermined wink movement and the second wink movement matches the second predetermined wink movement, the processor 104 can determine that the first wink movement and the second wink movement collectively form the specific blink movement.

In a first variation of the third embodiment, if the processor 104 determines that both of the first eye and the second have winked twice within one second, the processor 104 can determine that the first wink movement matches the first predetermined wink movement and the second wink movement matches the second predetermined wink movement. Accordingly, the processor 104 can determine that the first wink movement and the second wink movement collectively form the specific blink movement and accordingly zoom the visual content to be with the predetermined magnification.

In a second variation of the third embodiment, if the processor 104 determines that both of the first eye and the second have been closed for two seconds, the processor 104 can determine that the first wink movement matches the first predetermined wink movement and the second wink movement matches the second predetermined wink movement. Accordingly, the processor 104 can determine that the first wink movement and the second wink movement collectively form the specific blink movement and accordingly zoom the visual content to be with the predetermined magnification.

In different embodiments, the processor 104 can zoom in the visual content in different ways.

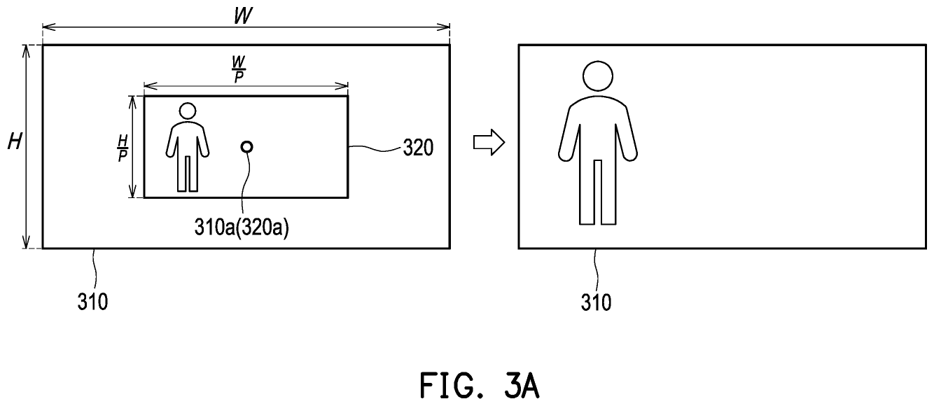

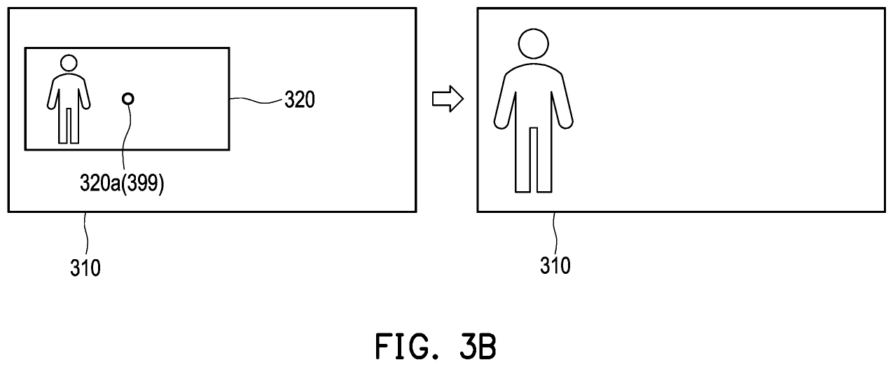

See FIG. 3A, which shows a schematic diagram of zooming in the visual content according to an embodiment of the disclosure. In FIG. 3A, the host 100 provides a visual content, and the user of the host 100 can see a part of the visual content via a field of view (FOV) 310. In the embodiment, the processor 104 can zoom in the visual content by a first magnification (referred to as P hereinafter). For better understanding the concept of the disclosure, the first magnification is assumed to be 2 in the following, but the disclosure is not limited thereto.

In FIG. 3A, the processor 104 determines a first reference area 320 within the FOV 310 of the visual content based on the first magnification. In the embodiment, the first reference area 320 has a center 320a, a width and a height, the center 320a of the first reference area 320 can correspond to a center 310a of the FOV 310a. In addition, the width of the first reference area 320 is characterized as W/P, the height of the first reference area 320 is characterized as H/P, wherein W is a width of the FOV 310, H is a height of the FOV 310. In the embodiments where P is assumed to be 2, the width of the first reference area 320 would be W/2, and the height of the first reference area 320 would be H/2.

Afterwards, the processor 104 can enlarge the first reference area 320 to fit the FOV 310 as shown on the right side of FIG. 3A.

See FIG. 3B, which shows a schematic diagram of zooming in the visual content according to an embodiment of the disclosure. In FIG. 3B, the host 100 provides a visual content, and the user of the host 100 can see a part of the visual content via the FOV 310. In the embodiment, the processor 104 can zoom in the visual content by the first magnification (i.e., P).

In FIG. 3B, the processor 104 determines the first reference area 320 within the FOV 310 of the visual content based on the first magnification. In the embodiment, the first reference area 320 has a center 320a, a width and a height, the center 320a of the first reference area 320 can correspond to a gaze point 399 of the user in the FOV 310. In addition, the width of the first reference area 320 is characterized as W/P, the height of the first reference area 320 is characterized as H/P, wherein W is a width of the FOV 310, H is a height of the FOV 310. In the embodiments where P is assumed to be 2, the width of the first reference area 320 would be W/2, and the height of the first reference area 320 would be H/2.

Afterwards, the processor 104 can enlarge the first reference area 320 to fit the FOV 310 as shown on the right side of FIG. 3B.

In one embodiment, after the processor 104 zooms in the visual content by the first magnification, the processor 104 can further zoom in the visual content by a second magnification in response to determining that the first wink movement matches the first predetermined wink movement again. In various embodiments, the second magnification can be equal or not equal to the first magnification, and the related operation of zooming in the visual content by the second magnification can be referred to the teachings in the above, which would not be repeated herein.

In different embodiments, the processor 104 can zoom out the visual content in different ways.

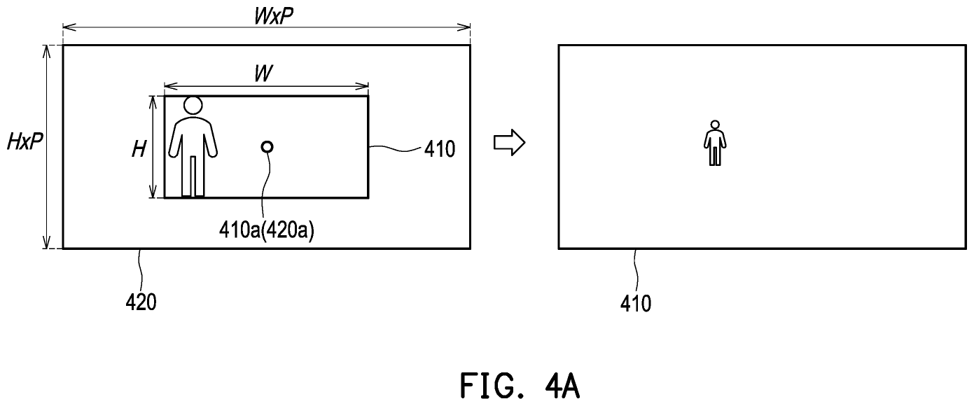

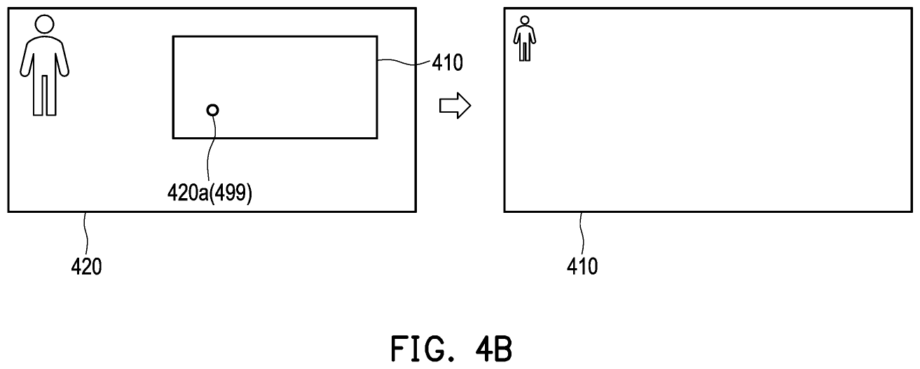

See FIG. 4A, which shows a schematic diagram of zooming out the visual content according to an embodiment of the disclosure. In FIG. 4A, the host 100 provides a visual content, and the user of the host 100 can see a part of the visual content via a FOV 410. In the embodiment, the processor 104 can zoom out the visual content by the first magnification (i.e., P).

In FIG. 4A, the processor 104 determines a second reference area 420 in the visual content based on the first magnification. In the embodiment, the second reference area 420 has a center 420a, a width and a height, the center 420a of the second reference area 420 can correspond to a center 410a of the FOV 410a. In addition, the width of the second reference area 420 is characterized as W×P, the height of the second reference area 420 is characterized as H×P, wherein W is a width of the FOV 410, H is a height of the FOV 410. In the embodiments where P is assumed to be 2, the width of the second reference area 420 would be 2 W, and the height of the second reference area 420 would be 2H.

Afterwards, the processor 104 can shrink the second reference area 420 to fit the FOV 410 as shown on the right side of FIG. 4A.

See FIG. 4B, which shows a schematic diagram of zooming out the visual content according to an embodiment of the disclosure. In FIG. 4B, the host 100 provides a visual content, and the user of the host 100 can see a part of the visual content via the FOV 410. In the embodiment, the processor 104 can zoom out the visual content by the first magnification (i.e., P).

In FIG. 4B, the processor 104 determines the second reference area 420 in the visual content based on the first magnification. In the embodiment, the second reference area 420 has a center 420a, a width and a height, the center 420a of the second reference area 420 can correspond to a gaze point 499 of the user in the FOV 410. In addition, the width of the second reference area 420 is characterized as W×P, the height of the second reference area 420 is characterized as H×P, wherein W is a width of the FOV 410, H is a height of the FOV 410. In the embodiments where P is assumed to be 2, the width of the second reference area 420 would be 2 W, and the height of the second reference area 420 would be 2H.

Afterwards, the processor 104 can enlarge the second reference area 420 to fit the FOV 410 as shown on the right side of FIG. 4B.

In one embodiment, after the processor 104 zooms out the visual content by the first magnification, the processor 104 can further zoom out the visual content by the second magnification in response to determining that the second wink movement matches the second predetermined wink movement again. In various embodiments, the second magnification can be equal or not equal to the first magnification, and the related operation of zooming out the visual content by the second magnification can be referred to the teachings in the above, which would not be repeated herein.

In various embodiments, the first magnification and/or the second magnification can be predetermined or defined by the user.

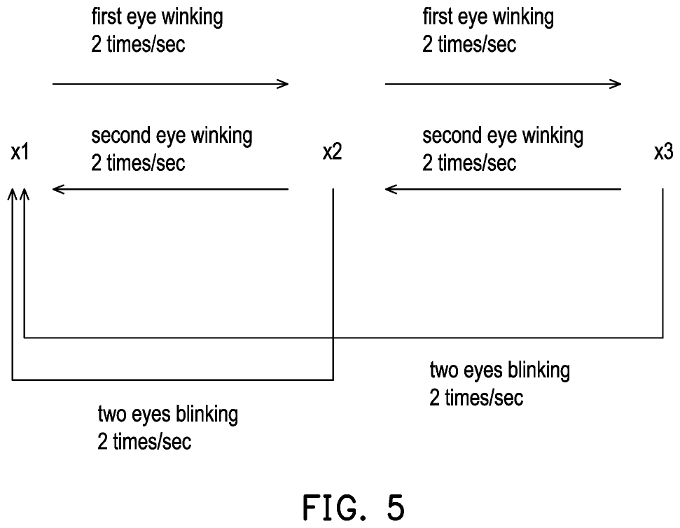

See FIG. 5, which shows a schematic diagram of zooming the visual content according to the first embodiment of the disclosure. In FIG. 5, the predetermined magnification can be represented by a status of “×1”. In this case, when the processor 104 determines that the first eye has winked 2 times/sec, the processor 104 can accordingly zooming in the visual content by a magnification, and the visual content being zoomed in can be, for example, two times of the predetermined magnification (represented by a status “×2”).

In one embodiment, if the processor 104 determines that the second eye has winked 2 times/sec in the status of “×2”, the processor 104 can accordingly zoom out the visual content by the magnification, and the visual content being zoomed out can be backed to the status of “×1”, but the disclosure is not limited thereto.

In one embodiment, when the processor 104 determines that the first eye has winked 2 times/sec in the status of “×2”, the processor 104 can accordingly zoom in the visual content by the magnification, and the visual content being zoomed in can be, for example, three times of the predetermined magnification (represented by a status of “×3”).

In one embodiment, when the processor 104 determines that the first eye and the second eye have blinked 2 times/sec in the statuses of “×2” or “×3”, the processor 104 can adjust the visual content to be with the predetermined magnification, i.e., the status of “×1”.

In other embodiments, the visual content can be further zoomed in to be four times of the predetermined magnification (represented by a status of “×4”) and/or five times of the predetermined magnification (represented by a status of “×5”) and so on, but the disclosure is not limited thereto.

In various embodiments, the magnification corresponding to each status can be defined by the user. For example, the status “×2” can be replaced with the status “×3”, and the status “×3” can be replaced with the status “×5” but the disclosure is not limited thereto.

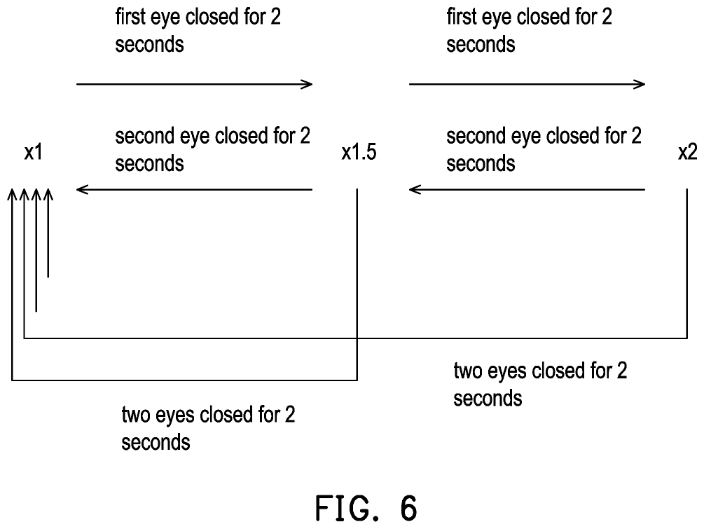

See FIG. 6, which shows a schematic diagram of zooming the visual content according to the second embodiment of the disclosure. In FIG. 6, the predetermined magnification can be represented by a status of “×1”. In this case, when the processor 104 determines that the first eye has been closed for 2 seconds, the processor 104 can accordingly zooming in the visual content by a magnification, and the visual content being zoomed in can be, for example, 1.5 times of the predetermined magnification (represented by a status “×1.5”).

In one embodiment, if the processor 104 determines that the second eye has been closed for 2 seconds in the status of “×1.5”, the processor 104 can accordingly zoom out the visual content by the magnification, and the visual content being zoomed out can be backed to the status of “×1”, but the disclosure is not limited thereto.

In one embodiment, when the processor 104 determines that the first eye has been closed for 2 seconds in the status of “×1.5”, the processor 104 can accordingly zoom in the visual content by the magnification, and the visual content being zoomed in can be, for example, two times of the predetermined magnification (represented by a status of “×2”).

In one embodiment, when the processor 104 determines that the first eye and the second eye have been closed for 2 seconds in the statuses of “×1.5” or “×2”, the processor 104 can adjust the visual content to be with the predetermined magnification, i.e., the status of “×1”.

In other embodiments, the visual content can be further zoomed in to be 2.5 times of the predetermined magnification (represented by a status of “×2.5”) and/or three times of the predetermined magnification (represented by a status of “×3”) and so on, but the disclosure is not limited thereto.

In various embodiments, the magnification corresponding to each status can be defined by the user. For example, the status “×1.5” can be replaced with the status “×3”, and the status “×2” can be replaced with the status “×5” but the disclosure is not limited thereto.

In summary, the embodiments of the disclosure can zoom the visual content based on the wink movements of the first eye and the second eye of the user. Accordingly, the user can zoom the visual content in an easier and more intuitive way.

It will be apparent to those skilled in the art that various modifications and variations can be made to the structure of the present invention without departing from the scope or spirit of the disclosure. In view of the foregoing, it is intended that the present disclosure cover modifications and variations of this invention provided they fall within the scope of the following claims and their equivalents.

1. A method for zooming a visual content, adapted to a host, comprising:
detecting a first wink movement of a first eye of a user and detecting a second wink movement of a second eye of the user;
in response to determining that the first wink movement matches a first predetermined wink movement but the second wink movement fails to match a second predetermined wink movement, zooming in the visual content; and
in response to determining that the second wink movement matches a second predetermined wink movement but the first wink movement fails to match the first predetermined wink movement, zooming out the visual content,
wherein the visual content has a predetermined magnification, and the method further comprises:
in response to determining that the first wink movement and the second wink movement collectively form a specific blink movement, zooming the visual content back to the predetermined magnification.

2. The method according to claim 1, wherein the first predetermined wink movement is identical to the second predetermined wink movement.

3. The method according to claim 1, comprising:
in response to determining that the first eye has winked for a first predetermined times within a first predetermined duration, determining that the first wink movement matches the first predetermined wink movement.

4. The method according to claim 3, wherein the first predetermined times is twice, and the first predetermined duration is one second.

5. The method according to claim 1, comprising:
in response to determining that the first eye has been closed for a first predetermined time length, determining that the first wink movement matches the first predetermined wink movement.

6. The method according to claim 5, wherein the first predetermined time length is two seconds.

7. The method according to claim 1, wherein the visual content has a predetermined magnification, and the method further comprises:
in response to determining that the first wink movement and the second wink movement collectively form a specific blink movement, zooming the visual content to be with the predetermined magnification.

8. The method according to claim 7, comprising:
in response to determining that each of the first eye and the second eye has blinked for a second predetermined times within a second predetermined duration, determining that the first wink movement and the second wink movement collectively form the specific blink movement.

9. The method according to claim 8, wherein the second predetermined times is twice, and the second predetermined duration is one second.

10. The method according to claim 7, comprising:
in response to determining that the first eye and the second eye have been closed for a second predetermined time length, determining that the first wink movement and the second wink movement collectively form the specific blink movement.

11. The method according to claim 10, wherein the second predetermined time length is two seconds.

12-14. (canceled)

15. The method according to claim 1, wherein after the step of zooming in the visual content by the first magnification, the method further comprises:
in response to determining that the first wink movement matches the first predetermined wink movement again, zooming in the visual content by a second magnification.

16. The method according to claim 1, wherein the step of zooming out the visual content comprises:
zooming out the visual content by the first magnification.

17. The method according to claim 16, wherein the step of zooming out the visual content by the first magnification comprises:
determining a second reference area in the visual content based on the first magnification; and
shrinking the second reference area to fit the field of view.

18. The method according to claim 17, wherein the second reference area has a center, a width and a height, the center of the second reference area corresponds to a center of the field of view or a gaze point of the user in the field of view, the width of the second reference area is characterized as W×P, the height of the second reference area is characterized as H×P, wherein W is a width of the field of view, H is a height of the field of view, and P is the first magnification.

19. A host, comprising:
a non-transitory storage circuit, storing a program code;
a processor, coupled to the non-transitory storage circuit and accessing the program code to perform:
detecting a first wink movement of a first eye of a user and detecting a second wink movement of a second eye of the user;
in response to determining that the first wink movement matches a first predetermined wink movement but the second wink movement fails to match a second predetermined wink movement, zooming in a visual content; and
in response to determining that the second wink movement matches a second predetermined wink movement but the first wink movement fails to match the first predetermined wink movement, zooming out the visual content,
wherein the visual content has a predetermined magnification, and the processor further performs:
in response to determining that the first wink movement and the second wink movement collectively form a specific blink movement, zooming the visual content back to the predetermined magnification.

20. A non-transitory computer readable medium, the computer readable medium recording an executable computer program, the executable computer program being loaded by a host to perform steps of:
detecting a first wink movement of a first eye of a user and detecting a second wink movement of a second eye of the user;
in response to determining that the first wink movement matches a first predetermined wink movement but the second wink movement fails to match a second predetermined wink movement, zooming in a visual content; and
in response to determining that the second wink movement matches a second predetermined wink movement but the first wink movement fails to match the first predetermined wink movement, zooming out the visual content,
wherein the visual content has a predetermined magnification, and the steps further comprise:
in response to determining that the first wink movement and the second wink movement collectively form a specific blink movement, zooming the visual content back to the predetermined magnification.
